(19) United States
(12) Patent Application Publication
(10) Pub. No.: US 2007/0171503 A1
(43) Pub. Date: Jul. 26, 2007

(54) Display device and method and keyboard using them

(76) Inventor: David Luo, Nimes (FR)

Correspondence Address: LERNER GREENBERG STEMER LLP, P O BOX 2480, HOLLYWOOD, FL, 33022-2480, US

(21) Appl. No.: 10/589,185

(22) PCT Filed: Feb. 10, 2005
(86) PCT No.: PCT/FR05/00297

§ 371 Date: Aug. 11, 2006

(30) Foreign Application Priority Data
Feb. 11, 2004 (FR) 0450240
Sep. 6, 2004 (FR) 0409424
Oct. 6, 2004 (FR) 0410516

(51) Int. Cl. G02B 26/00

(52) U.S. Cl. 359/237

(57) ABSTRACT

A display device has a light source for back-lighting a display surface, a modulator for modulating at least one physical characteristic of the light source, and at least two filters provided in the display surface. Each of the two filters corresponds to a physical characteristic value modulated by the modulator and to a message to be displayed on the display surface. The filters are placed on an optical path along which the light rays from the light source travel, and the messages at least partially overlap on the display surface. In certain embodiments, at least two of the filters are placed one on top of the other in the display surface. In other embodiments, at least two of the filters each consist of a set of filters, and the sets of filters are alternately juxtaposed in the display surface. In specific embodiments, the modulator varies the spectral band of the light reaching the filters, and the filters have different spectral bands of transparency.

The present invention aims at a display device and method and a keyboard using them. It is applicable, in particular, to portable electronic devices having several modes of operation, for example telephone and game, telephone and remote control, radio, portable television set, portable music player, positioning system, games console, personal digital assistant, Internet access terminal and public displays, such as advertising panels or signage etc.

Portable electronic devices are subject to a process of miniaturization demanded by users and which is made possible by technological advances. The keyboards of these devices therefore tend to be miniaturized, which makes them difficult to use: the pitch between two keys is of the same dimensions as the diameter of the fingers, so that there are a considerable number of data entry errors and/or the number of keys is very limited and entering each symbol involves pressing the keyboard several times. For example, so that the 26 letters of the alphabet can be entered using a keyboard consisting of a dozen keys, several keys must correspond to at least three letters, not counting letters with accents.

Furthermore, the number of operating modes for portable electronic devices is growing: mobile telephones incorporate photographic devices, agendas, calendar managers, games etc.

The keyboards of these electronic devices, designed for their main function, for example telephony, are not adapted to other modes of operation, where the user is used to different keyboard symbols.

In short, it is not possible to show on each key of the keyboard all the symbols to which the key should correspond; otherwise they might be unreadable.

In advertising panels or public displays or signage, where one wants to be able to display several messages, it is necessary either to juxtapose them, or to scroll the messages, for example by motorizing a device making the message media move. These systems are costly, occupy a large space or display messages that are of a small size, lessening their impact.

The present invention aims to remedy these inconveniences.

To this end, the present invention aims at a display device that comprises:
a light source adapted to light up, by backlighting, a display surface,
a modulation means that modulates at least one physical characteristic of said light source and
at least two filters in the display surface, each of which corresponds to a value of the physical characteristic modulated by the modulation means and to a message to be displayed on said display surface, said filters being placed on an optical path taken by the light rays coming from the light source, the messages being independent and overlapping at least partially in the display surface.

Thus, to make a message appear, for example a symbol on one of the keys of the keyboard or a message on a display panel, the characteristic of the light source is modulated so that this characteristic corresponds to the filter representing said message or symbol. By selecting the modulation of the light emitted, one of the symbols or one of the messages represented by one of the filters is made visible.

In addition, each message displayed can thus visually occupy, for the viewer, the greater part of the display surface and, in any case, an area overlapping, at least partially, the area covered by the other messages corresponding to the other filters.

In particular, at least two of said filters are superposed in the display surface.

In particular, each one of at least two of said filters comprises an assembly of filters, said filter assemblies being juxtaposed alternately in the display surface.

In particular, the system as briefly described above comprises at least one contactor designed to supply a signal representative of the interaction between a user and at least a part of the display surface.

Thus, the system can constitute an electrical button, a press-button, a contactor, a keyboard, a key, for example.

In particular, the system as briefly described above comprises a plurality of keys comprising a said contactor and each carrying a part of said display surface. In this way, a keyboard is made up.

In particular, the modulation means is adapted to modify the spectral band of light reaching said filters and said filters provide different spectral bands of transparency.

Thus, when the modulation means modifies the spectral band of the light rays reaching the filters, these take on different visual appearances, which results in making different symbols or messages visible on the display surface, for example on the keyboard key to which these filters are linked or on the display panel comprising these filters.

In particular, the light source comprises a light-emitting diode whose spectral band of emission varies according to the electrical characteristics of the power signal that is applied to it and the modulation means is adapted to modify said electrical characteristics.

Thus the construction of the light source, the optical system and the modulation means are simplified.

In particular, the light source comprises at least two independent electro-optical transducers placed in parallel on an optical path of light rays coming from the light source and going to the display surface, the modulation means being adapted to control alternately the light emission by one or other of the electro-optical transducers.

Thus the colors of the symbols or messages displayed alternately can be identical, the switching of the electro-optical transducers causing their successive display.

In particular, the modulation means is adapted to modify a principal axis of polarization of the light rays reaching the filters and the filters present different transparencies according to the axes of polarization. Thus, the different symbols or messages displayed alternately on the same display surface can present the same colors.

In particular, the light source comprises a plurality of electro-optical transducers equipped with optical fibers whose outputs form different symbols on the display surface, the modulation means being adapted to have light emitted by one of said electro-optical transducers.

Thus, the keyboard can be very thin.

In particular, the filters comprise components adapted to producing constructive or destructive interferences depending on the angle of incidence of the light rays and the modulation means is adapted to modify the angle of incidence of the light rays emitted by the light source.

In particular, the filters comprise holograms and the light source comprise at least two electro-optical transducers adapted to light up said holograms with different angles of incidence in order to make different symbols or messages appear on the display surface, the modulation means being adapted to modify the angle of incidence of the light rays emitted by the light source.

In particular, the filters comprise components adapted to produce total or partial reflections depending on the angle of incidence of the light rays and the light source comprises at least two electro-optical transducers adapted to light up said filters with different angles of incidence in order to make different symbols or messages appear on the display surface, the modulation means being adapted to modify the angle of incidence of the light rays emitted by the light source.

In particular, the filters comprise components adapted to realize different light transfers depending on the angle of incidence of the light rays and the light source comprises at least two electro-optical transducers adapted to light up said filters with different angles of incidence in order to make different symbols or messages appear on the display surface, the modulation means being adapted to modify the angle of incidence of the light rays emitted by the light source.

Thus, the different symbols or messages displayed alternately on the same display surface can present the same colors.

In particular, the optical path going from the light source to the display surface comprises at least one optical fiber.

Thus, this optical path can be very thin, for example less than 10 microns in thickness.

In particular, the optical path going from the light source to the display surface comprises at least one optical reflector element.

In particular, the display device as briefly described above comprises a reception means that receives signals coming from a keyboard whose keys comprise display surfaces, said signals representing the keyboard keys activated by the user, the reception means being adapted to assign different symbols to said signals, depending on the switching carried out by the switching means.

Thus, processing a symbol input on a keyboard key takes account of the symbol that was actually displayed on this key.

In particular, one at least of said filters is made up of an ink laid down with a marker on a transparent medium.

Thus, the user can customize the messages displayed by the systems.

The present invention also aims at an electronic system possessing at least one of the following functions: a personal digital assistant, an organizer, a telephone, a games console, a portable computer, an Internet access terminal, an Automatic Teller Machine, a dashboard, a watch, a remote control, a portable music player, a positioning system and an audiovisual signal receiver, office or leisure electronic equipment, a facsimile machine, a photocopier, a scanner, a recorded media reader, a home system installation, a household appliance, medical equipment, a measurement device, an automated analysis device, automobile equipment, a signboard, a switch, a games system, a decorative element, a lamp, an electrical button and a display panel, the electronic system comprising a display device as briefly described above.

According to a second aspect, the present invention aims at a display method comprising:
a step of switching a light source adapted to light up, by backlighting, a display surface,
a step of modulating at least one physical characteristic of said light source, the display surface being equipped with at least two filters, each corresponding to a value of the physical characteristic modulated by the modulation means and to a message to be displayed on said display surface, said filters being placed on an optical path taken by the light rays coming from the light source, the messages overlapping at least partially in the display surface.

As the advantages, aims and characteristics of this method and of this electronic system are similar to those of the display devices that were the subject of the first configuration as described in brief above, they are not repeated here.

Other advantages, aims and characteristics of the present invention will become apparent from the description that will follow, made, as an example that is in no way limiting, with reference to the accompanying drawings in which:

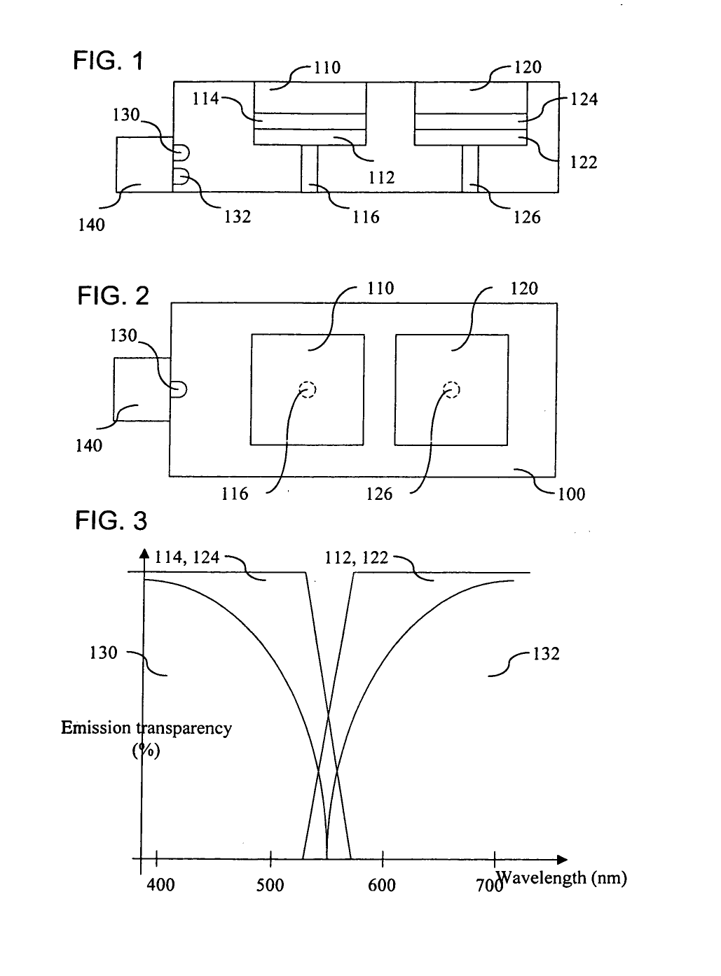

FIG. 1 represents, schematically, in cross-section, a first embodiment of a keyboard that is the subject of the present invention;

FIG. 2, represents, schematically, in top view, the keyboard illustrated in FIG. 1;

FIG. 3 represents the transparency curves for filters utilized in the keyboard illustrated in FIGS. 1 and 2;

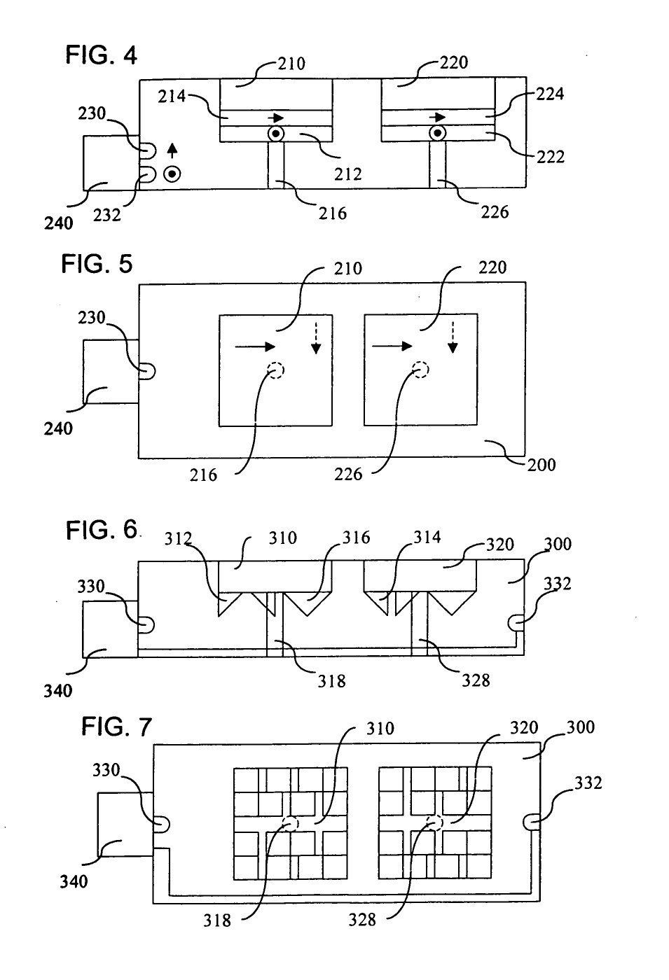

FIG. 4 represents, schematically, in cross-section, a second embodiment of a keyboard according to the present invention;

FIG. 5, represents, schematically, in top view, the keyboard illustrated in FIG. 4;

FIG. 6 represents, schematically, in cross-section, a third embodiment of a keyboard according to the present invention;

FIG. 7, represents, schematically, in top view, the keyboard illustrated in FIG. 6;

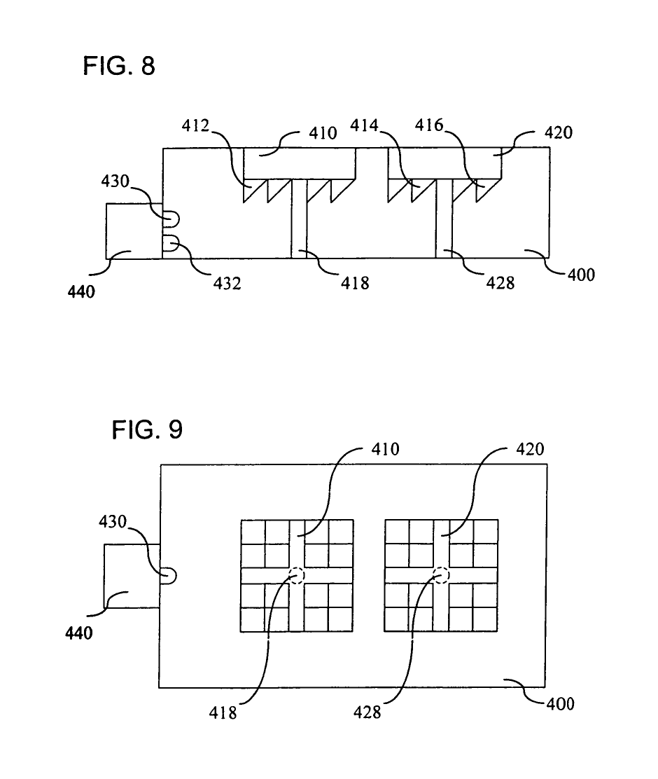

FIG. 8 represents, schematically, in cross-section, a fourth embodiment of a keyboard according to the present invention;

FIG. 9, represents, schematically, in top view, the keyboard illustrated in FIG. 8;

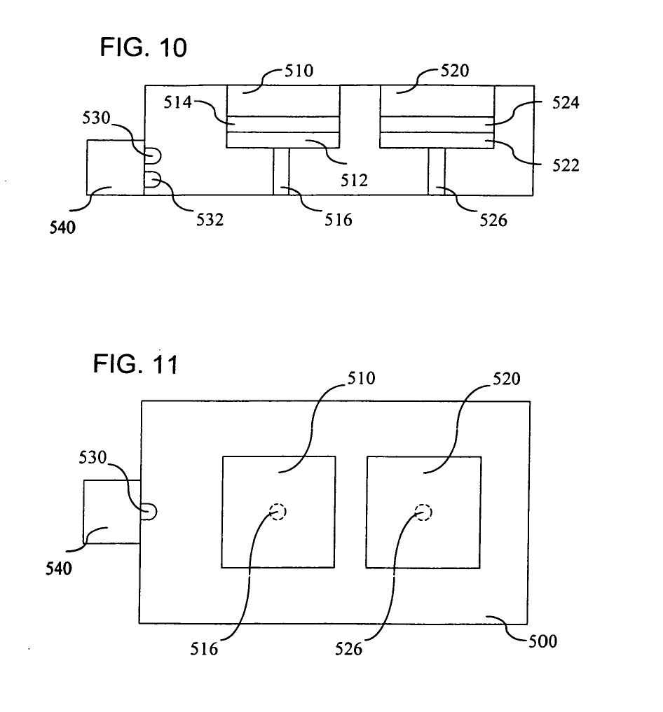

FIG. 10 represents, schematically, in cross-section, a fifth embodiment of a keyboard according to the present invention;

FIG. 11, represents, schematically, in top view, the keyboard illustrated in FIG. 10;

FIG. 12 represents, schematically, in cross-section, a sixth embodiment of a keyboard according to the present invention;

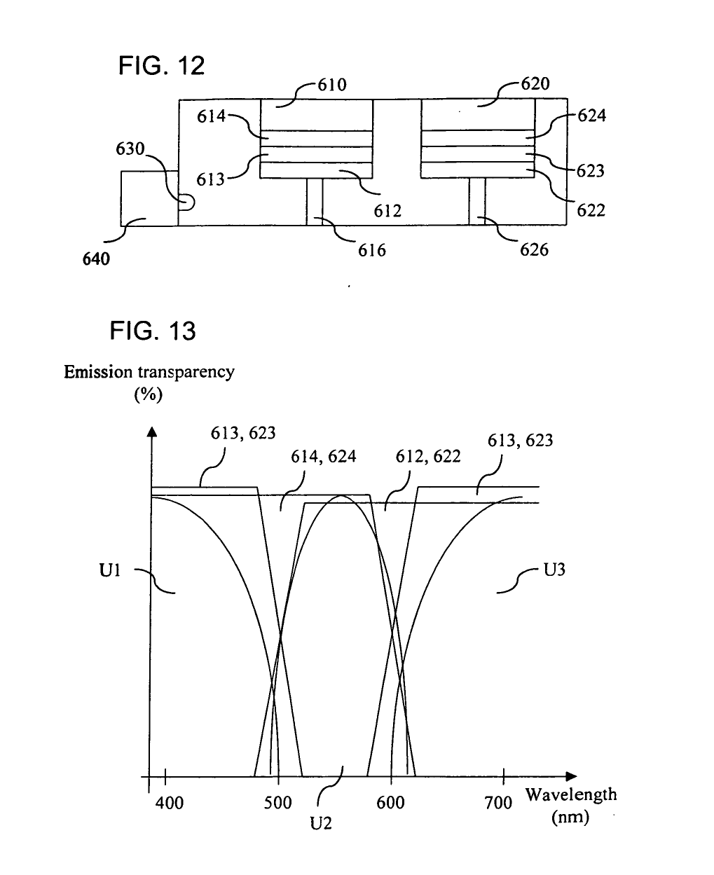

FIG. 13 represents the transparency curves for filters utilized in the keyboard illustrated in FIG. 12;

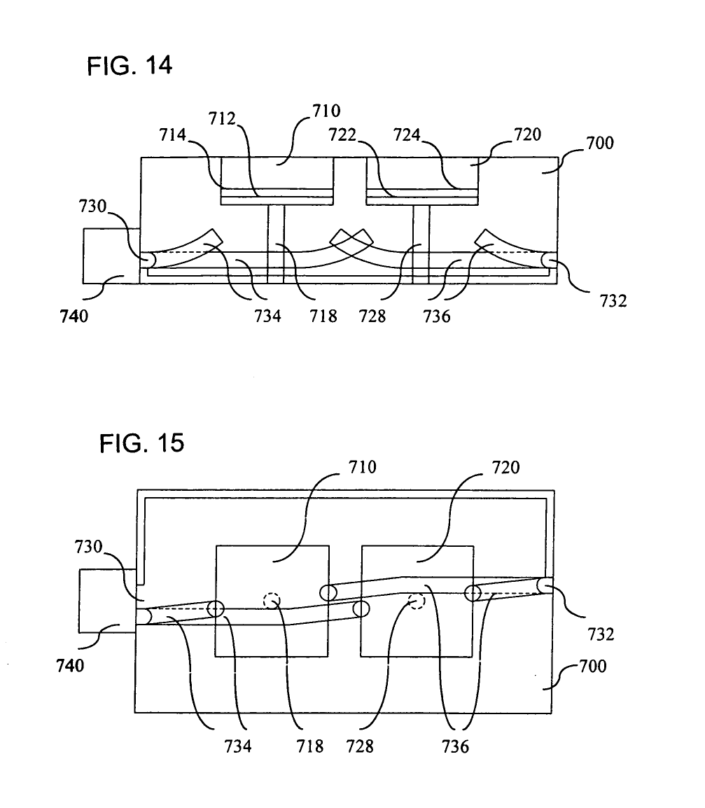

FIG. 14 represents, schematically, in cross-section, a seventh embodiment of a keyboard according to the present invention;

FIG. 15, represents, schematically, in top view, the keyboard illustrated in FIG. 14;

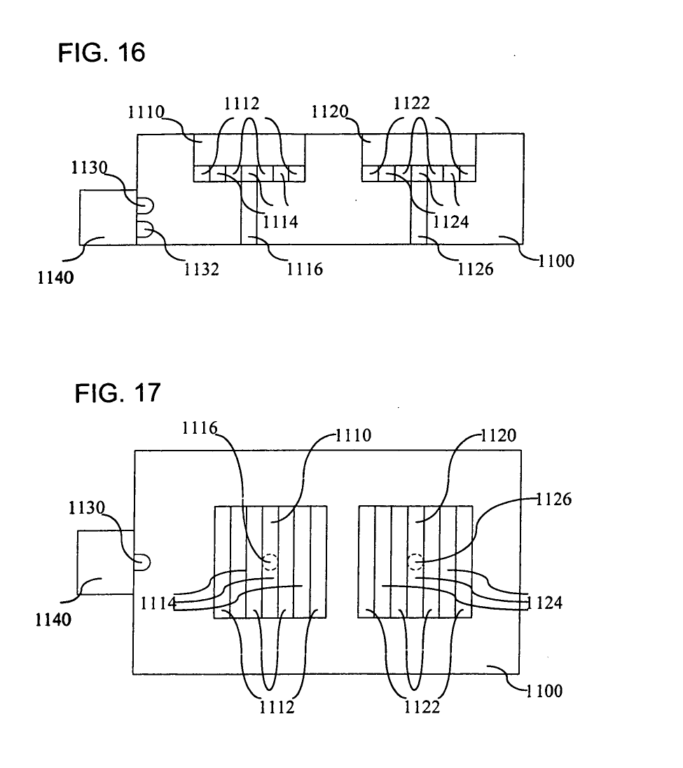

FIG. 16 represents, schematically, in cross-section, an eighth embodiment of a keyboard that is the subject of the present invention;

FIG. 17, represents, schematically, in top view, the keyboard illustrated in FIG. 16;

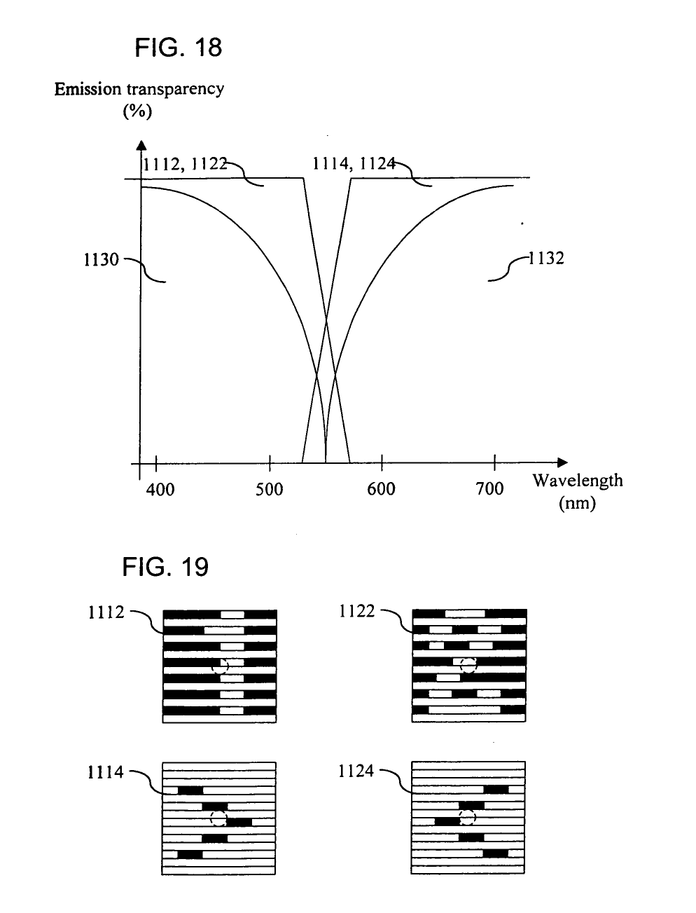

FIG. 18 represents the transparency curves for filters utilized in the eighth embodiment of the keyboard illustrated in FIGS. 16 and 17;

FIG. 19 represents, schematically, an example of messages, in this case symbols, carried by the keys of the eighth embodiment of the keyboard illustrated in FIGS. 16 through 18;

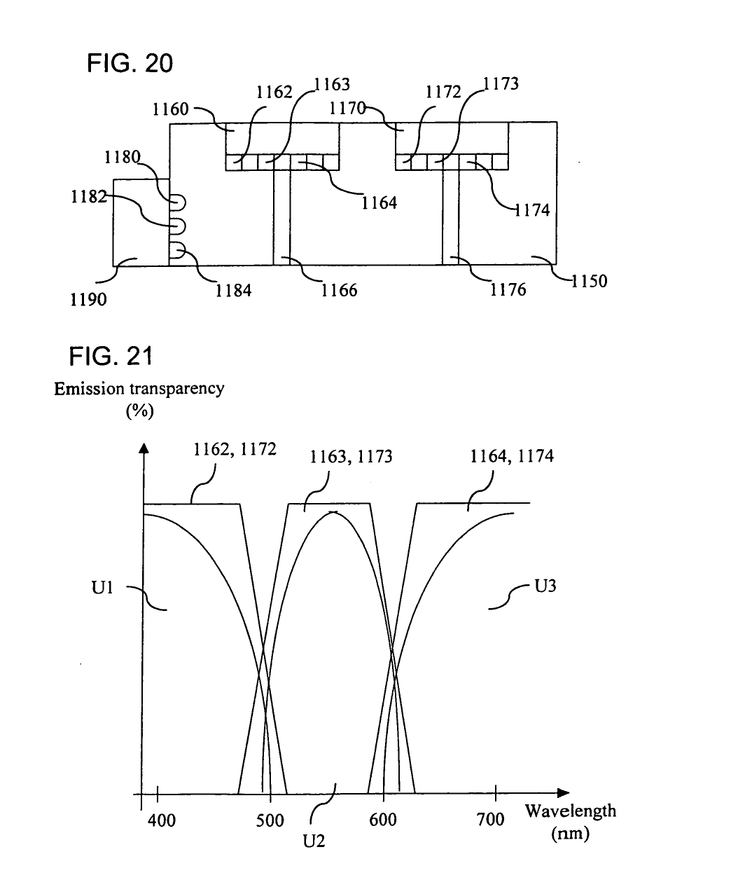

FIG. 20 represents, schematically, in cross-section, a ninth embodiment of a keyboard according to the present invention;

FIG. 21 represents the transparency curves for filters utilized in the ninth embodiment of the keyboard illustrated in FIG. 20;

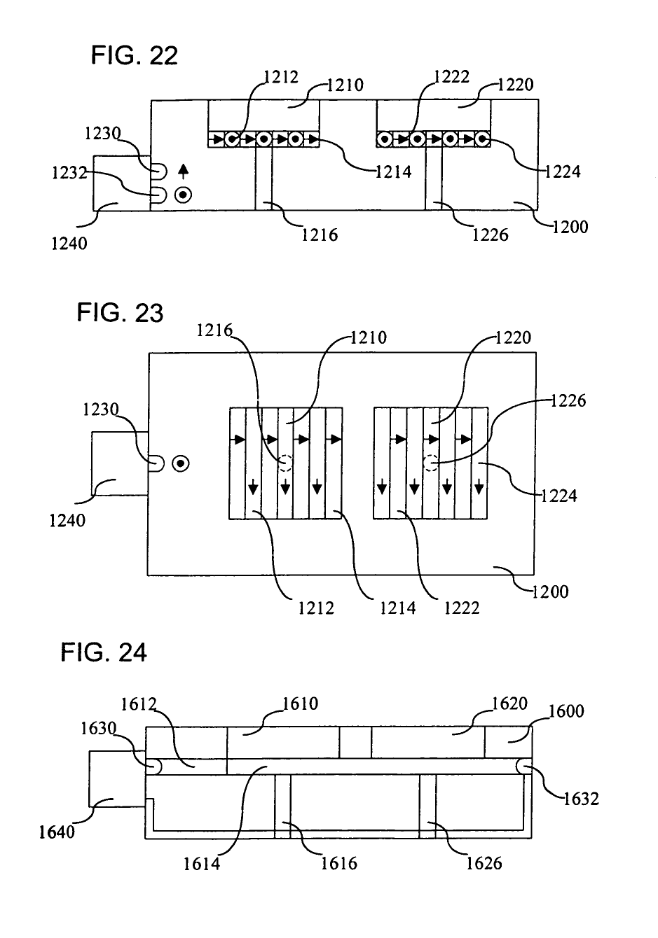

FIG. 22 represents, schematically, in cross-section, a tenth embodiment of a keyboard according to the present invention;

FIG. 23, represents, schematically, in top view, the keyboard illustrated in FIG. 22;

FIG. 24 represents, schematically, in cross-section, an eleventh embodiment of a keyboard according to the present invention;

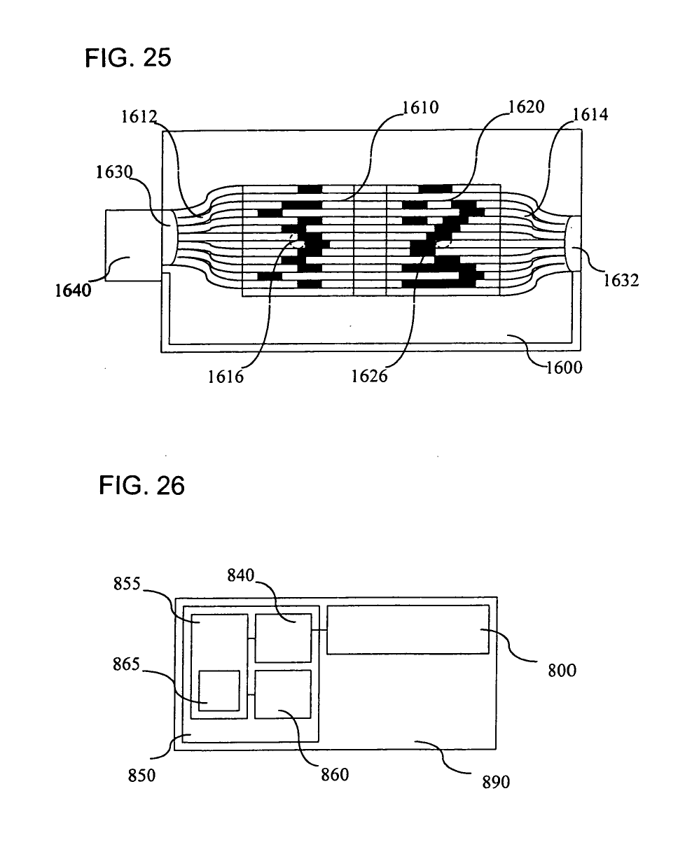

FIG. 25, represents, schematically, in top view, the keyboard illustrated in FIG. 24;

FIG. 26 represents, schematically, an electrical circuit associated with a keyboard as illustrated in one of the FIGS. 1 through 25;

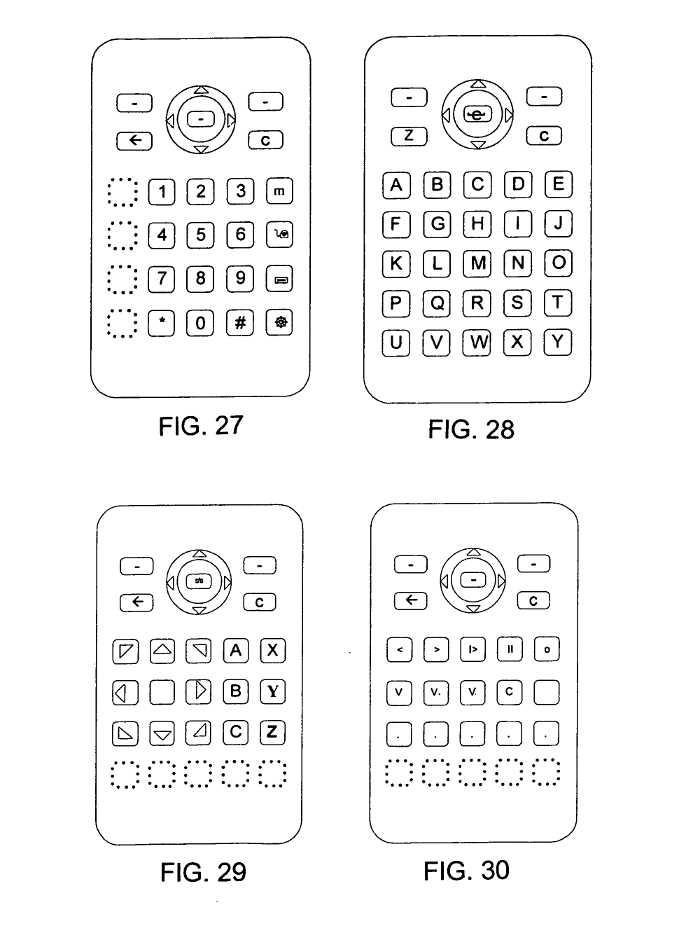

FIGS. 27 through 30 represent displays on keyboards adapted to different embodiments of the present invention;

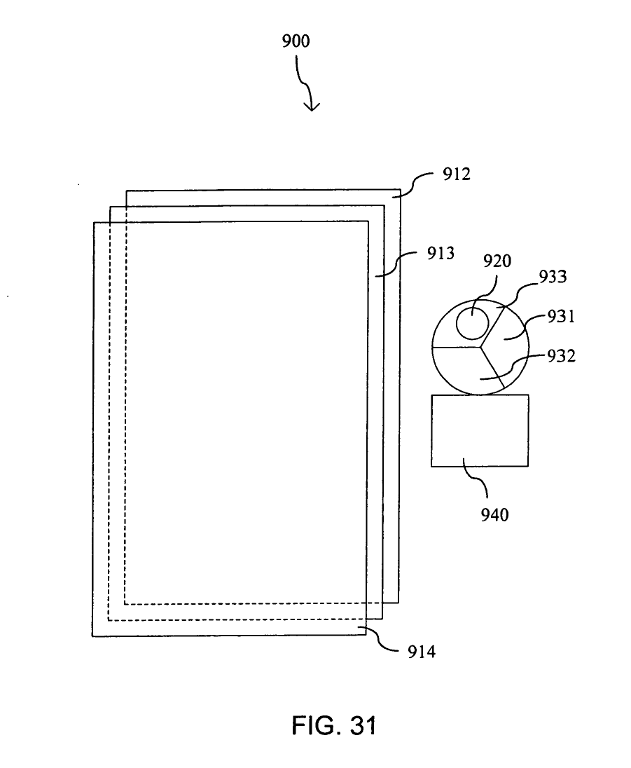

FIG. 31 represents, schematically, a display that is the subject of the present invention utilizing an operation similar to that described with reference to FIGS. 12 and 13 in order to display different messages and

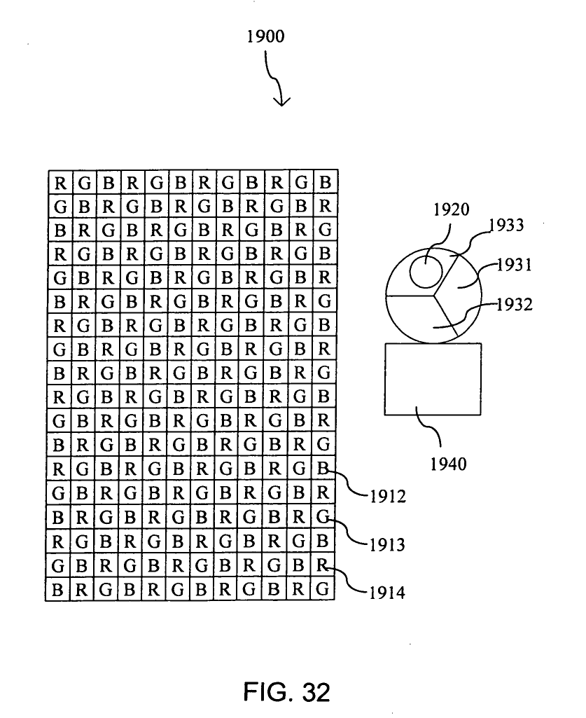

FIGS. 32 through 35 represent, schematically, in cross-section, a display surface of a special embodiment of a display that is the subject of the present invention utilizing an operation similar to that described with reference to FIGS. 20 and 21 to display different messages.

Throughout the description, light sources are specified that comprise one or more light-emitting diodes. However, the present invention is not limited to this type of electro-optical transducer, but covers all the light source types, for example incandescent bulbs or “fluorescent” bulbs.

In FIGS. 1 through 30, keyboards comprising a plurality of keys are shown. The present invention is not limited to this type of keyboard but, on the contrary, extends to keyboards with one single key, to keys, buttons and switches that implement the present invention.

Throughout the description, electrical contactors are specified that, for an example, make an electrical contact when the user presses on a keyboard key linked to said contactor. However, the present invention can be implemented with all contactor types, for example, contactors utilizing rubber conductors, mechanical contactors, tactile or non-tactile membranes, contactors utilizing optical switches, variations in impedance, capacitance for example, Reed, PushGate, Piezoelectric and Hall effect contactors.

In the description, many filters are specified that have at least one transparent portion. However, in order to compensate for the differences in light intensities that might arise between these transparent portion and the filtering portion, for the light rays that are not filtered by them, the portions called transparent can have a transparency coefficient of less than 100%.

In the first embodiment, illustrated on FIGS. 1 through 3, chromatic filters are used that form, in positive or negative, different symbols and, in order to make a given symbol appear, the spectral band of emission of a light source is modulated.

FIGS. 1 and 2 show a keyboard 100 comprising keys 110 and 120, equipped with filters, 112 and 114 respectively, key 110, and 122 and 124, key 120, and electrical contactors, 116 and 126 respectively. A light source is made up of two light-emitting diodes 130 and 132 controlled by a modulation means 140.

The electrical contactors 116 and 126 make an electrical contact between their terminals when keys 110 and 120 respectively are pressed or pushed. The modulation means 140 is an electrical switch that powers one or other of the light-emitting diodes 130 and 132.

The light-emitting diodes 130 and 132 emit in different spectral bands, preferably disjoint. For example, the light-emitting diode 130 emits light rays with wavelengths between 400 and 550 nanometers and the light-emitting diode 132 emits light rays with wavelengths between 550 and 700 nanometers.

Filters 112 and 114, on the one hand, and 122 and 124, on the other hand, are superposed, which means that they are placed in succession on the optical path of the light rays coming from light sources 130 and 132. Different symbols are formed on filters 112 and 114, for example “1” and “>”, filters 112 and 114 respectively being transparent outside the shapes of these symbols and having, in the shape of the symbols, absorption spectra respectively corresponding noticeably to the emission spectra of the light-emitting diodes 130 and 132, as shown with reference to FIG. 3.

Different symbols are formed on filters 122 and 124, for example “2” and “<”, filters 112 and 114 respectively being transparent inside the shapes of these symbols and having, outside the shapes of these symbols, absorption spectra respectively corresponding noticeably to the emission spectra of the light-emitting diodes 130 and 132, as shown with reference to FIG. 3.

When the modulation means 140 switches on light-emitting diode 130 and switches off light-emitting diode 132, the light source emits light rays with wavelengths of between 400 and 550 nanometers. The light rays emitted by the light source pass through filter 112 outside the symbol represented by this filter and are absorbed within the symbol because its absorption spectrum corresponds to the emission spectrum of the light-emitting diode 130. Then the remaining rays pass through filter 114 just as well within the shape of the symbol carried by filter 114 as they do outside the symbol because this filter is transparent in the emission spectrum of light-emitting diode 130. For key 110, the visible symbol is therefore the symbol carried by filter 112, in this case “1”, which appears in black on a blue background.

Equally, for key 120, the visible symbol is the symbol carried by filter 122, in this case “2”, which appears in blue on a black background.

When the modulation means 140 switches on light-emitting diode 132 and switches off light-emitting diode 130, the light source emits light rays with wavelengths of between 550 and 700 nanometers. The light rays emitted by the light source pass through filter 112 just as well outside the symbol represented by this filter as they do within this symbol because it is transparent in the emission spectrum of light-emitting diode 132. Then, the light rays are absorbed in the shape of the symbol carried by the filter 114 and pass through this filter outside the shape of this symbol, as the absorbing spectrum of the filter 114 corresponds to the emission spectrum of light-emitting diode 132.

For key 110, the visible symbol is therefore the symbol carried by filter 114, in this case “>”, which appears in black on an orange background.

Equally, for key 120, the visible symbol is that which is carried by filter 124, in this case “<” which appears in orange on a black background,

Thus, the implementation of the present invention enables, by the modulation value of a physical characteristic of the light emitted by the light source, in this case the wavelength of the emitted rays, the display of one or other symbol on each key of keyboard 100.

For example, the implementation of the present invention enables the symbols “>” and “<” to be displayed when the keyboard is used for games, to indicate the directions of movement needed to use the game, and the symbols “1” and “2” to be displayed when the keyboard is used to enter figures or numbers, in order to perform a calculation or make a telephone call. Other examples of applications are shown with reference to FIGS. 27 through 30.

In a variant of the first embodiment, illustrated in FIGS. 1 through 3, the light source comprises a light-emitting diode whose emission wavelength spectrum depends on at least one electrical characteristic of the signal that is applied to it, for example the voltage (see FIG. 12).

In a variant of the first embodiment, illustrated in FIGS. 1 through 3, the light source comprises two light-emitting diodes emitting in the same visible spectrum, each associated to a chromatic filter.

In a variant of the first embodiment, illustrated in FIGS. 1 through 3, the light source comprises a light-emitting diode followed by a dichroic polarizing filter placed optically after a single-cell liquid crystal screen and comprising a filter polarizing only on its upstream face on the light source side, the control for this liquid crystal screen making it possible to modify the liquid crystal screen's output polarization and, consequently, the color of the light rays coming from the light source.

It is noted here that the number of filters that can be superposed and the number of corresponding light-emitting diodes are not limited to two; there can be as many as the number of different spectral bands that the light source and the chromatic filters can have, for example ten if the disjoint spectral bands each cover a spectrum width of thirty nanometers, and that the filters have an absorption spectrum corresponding to the possible emission spectra of the light source.

In the second embodiment, illustrated on FIGS. 4 and 5, polarizing filters are used on which different symbols are formed and, in order to make a given symbol appear, the main polarization direction of a light source's light is modulated.

It is noted that in order to form the symbols on polarizing filters, one can take polarizing filters and locally destroy their polarization capability by local heating. Alternatively, a polarizing filter can be cut out and the desired shape stuck onto a key of a keyboard.

FIGS. 4 and 5 show a keyboard 200 comprising keys 210 and 220, equipped with filters, 212 and 214 respectively, key 210, and 222 and 224, key 220, and electrical contactors, 216 and 226 respectively. A light source is made up of two light-emitting diodes 230 and 232 controlled by a modulation means 240.

The electrical contactors 216 and 226 make an electrical contact between their terminals when keys 210 and 220 respectively are pressed or pushed. The modulation means 240 is an electrical switch that powers one or other of the light-emitting diodes 230 and 232.

The light-emitting diodes 230 and 232 emit visible light rays having, between the rays emitted by the two diodes, perpendicular polarization axes. For example, light-emitting diode 230 emits light rays whose polarization axis is parallel to the cross-section plane used in FIG. 4 and light-emitting diode 232 emits light rays whose polarization axis is perpendicular to this cross-section plane. To this end, for example, diodes 230 and 232 emit over the whole visible spectrum and are associated with or incorporate polarizing filters (not shown).

Filters 212 and 214, on the one hand, and filters 222 and 224, on the other hand, are superposed, that is to say that they are placed in succession on the optical path of the light rays coming from light sources 230 and 232. Different symbols are formed on filters 212 and 214, for example “1” and “>”, filters 212 and 214 respectively being transparent outside the shapes of these symbols and having, in the shape of the symbols, polarization axes respectively corresponding to the polarization axes of the light-emitting diodes 230 and 232.

Different symbols are formed on filters 222 and 224, for example “2” and “<”, filters 222 and 224 respectively being transparent inside the shapes of these symbols and having, outside the shape of the symbols, polarization axes respectively corresponding to the polarization axes of the light-emitting diodes 230 and 232.

When the modulation means 240 switches on light-emitting diode 230 and switches off light-emitting diode 232, the light source emits light rays whose polarization axis is parallel to the cross-section plane used in FIG. 4. The light rays emitted by the light source thus pass through filter 212 just as well outside the symbol represented by this filter as they do within this symbol. Then, the light rays pass through filter 214 outside the shape of the symbol carried by filter 214 and are stopped within the shape of the symbol. For key 210, the visible symbol is therefore the symbol carried by filter 214, in this case “>”, which appears in black on a background whose color corresponds to the emission spectrum of light-emitting diode 230, for example on a white background.

Equally, for key 220, the visible symbol is that which is carried by filter 224, in this case “<”, which appears lit up on a black background, the color of the symbol corresponding to the emission spectrum of light-emitting diode 230, for example white.

Conversely, when the modulation means 240 switches on light-emitting diode 232 and switches off light-emitting diode 230, the symbols which appear visible are the symbols carried by filters 212 and 222, which are “1” and “2” respectively.

Thus, the implementation of the present invention enables, by the modulation value of a physical characteristic of the light emitted by the light source, in this case the polarization of the emitted rays, the display of one or other symbol on each key of keyboard 200.

In a variant of the second embodiment, illustrated in FIGS. 4 and 5, the light source comprises a light-emitting diode followed by a single-cell liquid crystal screen and comprising only an input polarizing filter, the control for this liquid crystal screen making it possible to modify the liquid crystal screen's output polarization.

In the third embodiment, illustrated on FIGS. 6 and 7, diopters are used that form the image elements of different symbols and, in order to make a given symbol appear, the direction of origin of light rays from the light source is modulated.

FIGS. 6 and 7 show a keyboard 300 comprising keys 310 and 320, equipped with diopters 312, 314 and 316, different shapes and electrical contactors, 318 and 328 respectively. A light source is made up of two light-emitting diodes 330 and 332 controlled by a modulation means 340.

It is noted that the diopters represented in these figures are not to the same scale as the other elements, in particular the keys of the keyboard.

The electrical contactors 318 and 328 make an electrical contact between their terminals when keys 310 and 320 respectively are pressed or pushed. The modulation means 340 is an electrical switch that powers one or other of the light-emitting diodes 330 and 332.

The light-emitting diodes 330 and 332 emit visible light rays in opposite points of keyboard 300. For example, light-emitting diode 330 emits light rays from the left of keyboard 300 and light-emitting diode 332 emits light rays from the right of keyboard 300.

Diopters 312 are adapted to reflect, towards the key with which they are associated, the single light rays originating from light-emitting diode 330. For example, diopters 312 present, in cross section, a prism shape where a vertical side is oriented from the side of light-emitting diode 330 and an oblique side, making a 45-degree angle with the two other sides of the prism, is oriented towards light-emitting diode 332.

Diopters 314 are adapted to reflect, towards the key with which they are associated, the single light rays originating from light-emitting diode 332. For example, diopters 314 present, in cross section, a prism shape where a vertical side is oriented from the side of light-emitting diode 332 and an oblique side, making a 45-degree angle with the two other sides of the prism, is oriented towards light-emitting diode 330.

Diopters 316 are adapted to reflect, towards the key with which they are associated, the light rays originating from each of the light-emitting diodes 330 and 332. For example, diopters 316 present, in cross section, a prism shape where two oblique symmetrical sides each make a 45-degree angle with a side of the prism parallel to the surface of the key.

Where an image element does not form part of either of the symbols that may be displayed by a key, this image element does not have a diopter.

Where an image element only forms part of the symbol made to appear with light-emitting diode 330, this image element has a diopter 312. Where an image element only forms part of the symbol made to appear with light-emitting diode 332, this image element has a diopter 314. Where an image element forms part of the two symbols made to appear with light-emitting diodes 330 and 332, this image element has a diopter 316.

When the modulation means 340 switches on light-emitting diode 330 and switches off light-emitting diode 332, the image elements which form part of a first symbol appear lit up. When the modulation means 340 switches on light-emitting diode 332 and switches off light-emitting diode 330, the image elements which form part of a second symbol appear lit up.

Thus, the implementation of the present invention enables, by the modulation value of a physical characteristic of the light emitted by the light source, in this case the direction of the emitted rays, the display of one or other symbol on each key of keyboard 300.

In a variant of the third embodiment, the diopter assemblies are replaced by networks of oriented grooves on a metallic surface lit by the side on which the key is found, the oriented grooves causing local reflections, for the image points that one wants to make appear. For example, the light-emitting diodes are positioned at 90 degrees with reference to the center of the keyboard and the oriented grooves are oriented, locally, perpendicular to the direction of the light rays coming from the light-emitting diode that has to make the image appear.

In the fourth embodiment, illustrated on FIGS. 8 and 9, multi-layer processes are used that, according to the wavelength of the incident light, are either very reflective or not very reflective and which are applied to the image elements of different symbols. In order to make a given symbol appear, the wavelength of the light rays emitted by the light source is modulated.

FIGS. 8 and 9 show a keyboard 400 comprising keys 410 and 420, equipped with prisms 412, 414 and 416, different shapes and electrical contactors, 418 and 428 respectively. A light source is made up of two light-emitting diodes 430 and 432 controlled by a modulation means 440.

It is noted that the diopters represented in these figures are not to the same scale as the other elements, in particular the keys of the keyboard.

The electrical contactors 418 and 428 make an electrical contact between their terminals when keys 410 and 420 respectively are pressed or pushed. The modulation means 440 is an electrical switch that powers one or other of the light-emitting diodes 430 and 432.

Light-emitting diodes 430 and 432 emit visible light rays of different wavelengths, for example centered on 440 and 660 nanometers respectively.

Prisms 412 are adapted to cause constructive and destructive interferences in order to reflect, towards the key to which they are associated, the single light rays coming from light-emitting diode 430. To this end, prisms 412 present, in cross section, a prism shape where a vertical side is oriented from the side of the light-emitting diodes and an oblique side, making a 45-degree angle with the two other sides of the prism, is treated with a multi-layer process adapted to reflect light rays whose wavelength is around 440 nanometers and to not reflect light rays whose wavelength is around 660 nanometers.

Prisms 414 are adapted to cause constructive and destructive interferences in order to reflect, towards the key to which they are associated, the single light rays coming from light-emitting diode 432. To this end, prisms 414 present, in cross section, a prism shape where a vertical side is oriented from the side of the light-emitting diodes and an oblique side, making a 45-degree angle with the two other sides of the prism, is treated with a multi-layer process adapted to reflect light rays whose wavelength is around 660 nanometers and to not reflect light rays whose wavelength is around 440 nanometers.

Prisms 416 are adapted to cause constructive and destructive interferences in order to reflect, towards the key to which they are associated, the light rays coming from the two light-emitting diodes 430 and 432. To this end, prisms 414 present, in cross section, a prism shape where a vertical side is oriented from the side of the light-emitting diodes and an oblique side, making a 45-degree angle with the two other sides of the prism, is treated with a metallic treatment making a partially reflective mirror.

Where an image element does not form part of either of the symbols that may be displayed by a key, this image element does not have a prism.

Where an image element only forms part of the symbol made to appear with light-emitting diode 430, this image element has a prism 412. Where an image element only forms part of the symbol made to appear with light-emitting diode 432, this image element has a prism 414. Where an image element forms part of the two symbols made to appear with light-emitting diodes 430 and 432, this image element has a prism 416.

When the modulation means 440 switches on light-emitting diode 430 and switches off light-emitting diode 432, the image elements which form part of a first symbol appear lit up. When the modulation means 440 switches on light-emitting diode 432 and switches off light-emitting diode 430, the image elements which form part of a second symbol appear lit up.

Thus, the implementation of the present invention enables, by the modulation value of a physical characteristic of the light emitted by the light source, in this case the wavelength of the emitted rays, the display of one or other symbol on each key of keyboard 400.

In a variant of the fourth embodiment, illustrated in FIGS. 8 and 9, the light source comprises a light-emitting diode whose emission wavelength spectrum depends on at least one electrical characteristic of the signal that is applied to it, for example the voltage.

In a variant of the fourth embodiment, illustrated in FIGS. 8 and 9, the light source comprises two light-emitting diodes emitting in the same visible spectrum, each associated to one chromatic filter.

In a variant of the fourth embodiment, illustrated in FIGS. 8 and 9, the multi-layer interface causes the reflection of several spectral bands spread over the visible spectrum and corresponding to the spectral bands emitted by the light source, which makes it possible to display symbols relatively less colored and contrasted than the 440- and 660-nanometer wavelengths.

In the fifth embodiment, illustrated on FIGS. 10 through 11, photoluminescent compounds are used forming different symbols and, in order to make a given symbol appear, the spectral band of emission of a light source is modulated.

It is recalled here that a photoluminescent compound is a chemical compound that has the particularity of emitting light in a first spectrum (in this case a visible spectrum) when it receives light in a second spectrum (in this case a visible and/or infrared light spectrum).

FIGS. 10 and 11 show a keyboard 500 comprising keys 510 and 520, equipped with filters, 512 and 514 respectively, key 510, and 522 and 524, key 520, and electrical contactors, 516 and 526 respectively. A light source is made up of two light-emitting diodes 530 and 532 controlled by a modulation means 540.

The electrical contactors 516 and 526 make an electrical contact between their terminals when keys 510 and 520 respectively are pressed or pushed. The modulation means 540 is an electrical switch that powers one or other of the light-emitting diodes 530 and 532.

Light-emitting diodes 530 and 532 emit in spectral bands, preferably disjoint, corresponding to the receive spectral bands of two photoluminescent compounds utilized to form filters 512 and 522 respectively, on the one hand, and filters 514 and 524, on the other hand.

Filters 512 and 514, on the one hand, and 522 and 524, on the other hand, are superposed, that is to say that they are placed in succession on the optical path of the light rays coming from light sources 530 and 532. Different symbols are formed on filters 512 and 514, for example “1”, and “>”, filters 512 and 514 respectively being transparent to the excitation wavelengths of the photoluminescent compound carried by filter 514 and to the wavelengths emitted by the photoluminescent compound carried by filter 512.

Different symbols are formed on filters 522 and 524, for example “2” and “<”, filters 522 and 524 respectively being transparent to the excitation wavelengths of the photoluminescent compound carried by filter 524 and to the wavelengths emitted by the photoluminescent compound carried by filter 522.

When the modulation means 540 switches on light-emitting diode 530 and switches off light-emitting diode 532, the light source emits light rays that excite the photoluminescent compound carried by filters 512 and 522, causing the symbols formed with this compound to appear, in this case “1” and “2”.

When the modulation means 540 switches on light-emitting diode 532 and switches off light-emitting diode 530, the light source emits light rays that excite the photoluminescent compound carried by filters 514 and 524, causing the symbols formed with this compound to appear, in this case “>” and “<”.

Thus, the implementation of the present invention enables, by the modulation value of a physical characteristic of the light emitted by the light source, in this case the wavelength of the emitted rays, the display of one or other symbol on each key of keyboard 500.

In a variant of the fifth embodiment, illustrated in FIGS. 10 and 11, the light source comprises a light-emitting diode whose emission wavelength spectrum depends on at least one electrical characteristic of the signal that is applied to it, for example the voltage.

In a variant of the fifth embodiment, illustrated in FIGS. 10 and 11, the light source comprises two light-emitting diodes emitting in the same visible spectrum, each associated to one chromatic filter.

It is noted here that the number of filters that can be superposed and the number of corresponding light-emitting diodes are not limited to two but can match the number of different spectral bands that the light source can emit and the number of different excitation wavelengths that the photoluminescent compounds can have.

In the sixth embodiment, illustrated on FIGS. 12 and 13, chromatic filters are used that form, in positive or negative, different symbols and, in order to make a given symbol appear, the spectral band of emission of a light source is modulated.

FIG. 12 shows a keyboard 600 comprising keys 610 and 620, equipped with filters, 612, 613 and 614 respectively, key 610, and 622, 623 and 624, key 620, and electrical contactors, 616 and 626 respectively. A light source is made up of a light-emitting diode 630 whose emission spectrum is controlled by a modulation means 640, for example by controlling the power supply voltage of light-emitting diode 630.

The electrical contactors 616 and 626 make an electrical contact between their terminals when keys 610 and 620 respectively are pressed or pushed. The modulation means 640 is a voltage supply modulator of the light-emitting diode 630.

Light-emitting diode 630 is adapted to emit light in three different spectral bands, preferably disjoint, depending on the voltage applied to it. For example, light-emitting diode 630 emits light rays with wavelengths of between 400 and 500 nanometers when it is powered with a first voltage U1, light rays with wavelengths of between 500 and 600 nanometers when it is powered by a second voltage U2 and light rays with wavelengths of between 600 and 700 nanometers when it is powered by a third voltage U3.

Filters 612 through 614, on the one hand, and 622 through 624, on the other hand, are superposed, which means that they are placed in succession on the optical path of the light rays coming from the light-emitting diode 630. Different symbols are formed on filters 612, 613 and 614, for example “1”, “>” and “εE”, filters 612 through 614 respectively being transparent outside the shapes of these symbols and having, in the shape of the symbols, absorption spectra respectively corresponding noticeably to the three emission spectra of the light-emitting diode 630 indicated above, as shown with reference to FIG. 13.

Different symbols are formed on filters 622, 623 and 224, for example “2”, “<” and “$”, filters 622 through 624 respectively being transparent inside the shapes of these symbols and having, outside the shape of these symbols, absorption spectra respectively corresponding noticeably to the emitting spectra of the light-emitting diode 630 indicated above, as shown with reference to FIG. 13.

When the modulation means 640 powers the light-emitting diode 630 with voltage U1, the light source emits light rays with wavelengths of between 400 and 500 nanometers. The light rays emitted by the light source pass through filter 612 outside the symbol represented by this filter and are absorbed within the symbol because its absorption spectrum corresponds to the emission spectrum of light-emitting diode 630. Then the remaining rays pass through filters 613 and 614 just as well within the shape of the symbol carried by these filters as they do outside the symbol because these filters are transparent in the emission spectrum of light-emitting diode 630. For key 610, the visible symbol is therefore the symbol carried by filter 612, in this case “1”, which appears in black on a blue-violet background.

Equally, for key 620, the visible symbol is the symbol carried by filter 622, in this case “2”, which appears in blue-violet on a black background.

When the modulation means 640 switches on light-emitting diode 630 with the voltage U2, the light source emits light rays with wavelengths of between 500 and 600 nanometers.

The light rays pass through filter 612 just as well within the symbol represented by this filter as they do outside this symbol, because it is transparent in the emission spectrum of light-emitting diode 630.

Then, the light rays pass through filter 613 outside the shape of the symbol represented by this filter and are absorbed in this symbol, as it's absorbing spectrum corresponds to the emission spectrum of light-emitting diode 630. Then, the remaining light rays pass through filter 614 just as well within the shape of the symbol carried by these filters as they do outside the symbol because these filters are transparent in the emission spectrum of light-emitting diode 630. For key 610, the visible symbol is therefore the symbol carried by filter 613, in this case “>”, which appears in black on a green background.

Equally, for key 620, the visible symbol is the symbol carried by the filter 623, in this case “<”, which appears in green on a black background.

When the modulation means 640 powers the light-emitting diode 630 with voltage U3, the light source emits light rays with wavelengths of between 600 and 700 nanometers.

The light rays emitted by the tight source pass through filter 612 and 613 just as well within the shape of the symbol carried by these filters as they do outside the symbol because these filters are transparent in the emission spectrum of light-emitting diode 630.

Then the light-emitting rays pass through filter 614 outside the symbol represented by this filter and are absorbed within the symbol because its absorption spectrum corresponds to the emission spectrum of light-emitting diode 630.

For key 610, the visible symbol is therefore the symbol carried by filter 614, in this case “ε”, which appears in black on a red-orange background.

Equally, for key 620, the visible symbol is the symbol carried by filter 624, in this case “$”, which appears in red-orange on a black background.

Thus, the implementation of the present invention enables, by the modulation value of a physical characteristic of the light emitted by the light source, in this case the wavelength of the emitted rays, the display of one or other symbol on each key of keyboard 600.

In a variant of the sixth embodiment, illustrated in FIGS. 12 through 13, the light source comprises three light-emitting diodes emitting in three visible spectra or each associated to a chromatic filter.

It is noted here that the number of filters that can be superposed and the number of corresponding light-emitting diodes are not limited to two but can match the number of different spectral bands that the light source and the chromatic filters can have, for example ten if the disjoint spectral bands each cover a spectrum width of thirty nanometers, and that the filters have an absorption spectrum corresponding to the possible emission spectra of the light source.

In the seventh embodiment, illustrated in FIGS. 14 through 15, holographic images of different symbols are used, images that appear when the direction of the incident rays corresponds to their angle of reference. In order to make a given symbol appear, the direction of origin of the light rays from the light source is modulated to make this direction correspond to one of those used as a reference for the creation of the holograms.

FIGS. 14 and 15 show a keyboard 700 comprising keys 710 and 720, equipped with holograms 712 and 714, key 710, and 722 and 724, key 720, and electrical contactors, 718 and 728 respectively. A light source is made up of two light-emitting diodes 730 and 732, associated respectively to optic fiber networks 734 and 736 and controlled by a modulation means 740.

The electrical contactors 718 and 728 make an electrical contact between their terminals when keys 710 and 720 respectively are pressed or pushed. The modulation means 740 is an electrical switch that powers one or other of the light-emitting diodes 730 and 732.

Light-emitting diodes 730 and 732 emit visible light rays in the opposite points of keyboard 700. For example, light-emitting diode 730 emits light rays from the left of keyboard 700 and light-emitting diode 732 emits light rays from the right of keyboard 700. Optic fiber network 734, associated to light-emitting diode 730, lights keys 710 and 720 at the same angle corresponding to the angle of reference of the holograms present on filters 712 and 722. Optic fiber network 736, associated to light-emitting diode 732, lights keys 710 and 720 at the same angle corresponding to the angle of reference of the holograms present on filters 714 and 724.

It is noted that the angles of incidence, on the holograms, of the rays coming from diodes 732 and 732 are different. The angle of incidence of the rays coming from diode 730 is that used as reference to make holograms 712 and 722 appear, while the angle of incidence of the rays coming from diode 732 is that used as reference to make holograms 714 and 724 appear.

Holograms 712 and 714 represent different symbols, for example “1”, and “>” respectively. Holograms 722 and 724 represent different symbols, for example “2” and “>” respectively.

When the modulation means 740 switches on light-emitting diode 730 and switches off light-emitting diode 732, the symbols represented by holograms 712 and 722, “1” and “2”, appear visible on keyboard 700. When the modulation means 740 switches on light-emitting diode 732 and switches off light-emitting diode 730, the symbols represented by holograms 714 and 724, “>” and “<” appear visible on keyboard 700.

Thus, the implementation of the present invention enables, by the modulation value of a physical characteristic of the light emitted by the light source, in this case the direction of the emitted rays, the display of one or other symbol on each key of keyboard 700.

It is noted here that the number of holograms that can be superposed and the number of corresponding light-emitting diodes are not limited to two but can go up to the number required.

In a variant of the seventh embodiment illustrated on FIGS. 14 and 15, it is different wavelengths that are used to make the different superposed holograms carried by the same key appear.

It is noted that, in order to implement the present invention, a keyboard could be divided up into several groups of keys, each group of keys forming one of the embodiments of the present invention, for example one of the embodiments presented above.

It is also noted that the symbols to be displayed can be included when the keyboard is manufactured or, for special embodiments, these symbols can be realized retroactively, on blank medium that can be written on, for example made up of at least one filter layer sensitive to a physical characteristic, for example heat, for example supplied by a laser ray whose generator is in the form of a pen.

Inscribing the symbols on the different filter layers is done, for example, by means of a tool emitting several light sources with different characteristics (for example: a laser source with multiple power-levels), each of which lets a specific filter be marked (or burned). This tool could take the form of a pen, thus making it easier to use. In this way, users in different countries could, for example, trace out the letters of their own specific alphabets.

In the eighth embodiment, illustrated on FIGS. 16 through 19, chromatic filters are used that form, in positive or negative, different symbols and, in order to make a given symbol appear, the spectral band of emission of a light source is modulated.

FIGS. 16 and 17 show a keyboard 1100 comprising keys 1110 and 1120, equipped with two filter assemblies juxtaposed alternately, 1112 and 1114 respectively, key 1110, and 1122 and 1124, key 1120, and electrical contactors, 1116 and 1126 respectively. A light source is made up of two light-emitting diodes 1130 and 1132 controlled by a modulation means 1140.

The electrical contactors 1116 and 1126 make an electrical contact between their terminals when keys 1110 and 1120 respectively are pressed or pushed. The modulation means 1140 is an electrical switch that powers one or other of the light-emitting diodes 1130 and 1132.

The light-emitting diodes 1130 and 1132 emit in different spectral bands, preferably disjoint. For example, the light-emitting diode 1130 emits light rays with wavelengths of between 400 and 550 nanometers and the light-emitting diode 1132 emits light rays with wavelengths of between 550 and 700 nanometers.

Filter assemblies 1112 and 1114, on the one hand, and 1122 and 1124, on the other hand, are juxtaposed alternately, that is to say that between two filters 1112 and 1122 respectively, there is a filter 1114 and 1124 respectively, and conversely and that these filter assemblies are, optically, parallel on the optical paths of the light rays coming from light sources 1130 and 1132. Different symbols are formed on filter assemblies 1112 and 1114, for example “1” and “>”, filters 1112 and 1114 being absorbent for all the visible wavelengths outside the shapes of these symbols and having, within the shape of the symbols, transmission spectra respectively corresponding noticeably to the emission spectra of light-emitting diodes 1130 and 1132, as shown with respect to FIG. 18.

Different symbols are formed on filter assemblies 1122 and 1124, for example “2” and “<”, filters 1122 and 1124 being absorbent for all the wavelengths outside the shapes of these symbols and having, within the shape of the symbols, absorption spectra respectively corresponding noticeably to the emission spectra of light-emitting diodes 1130 and 1132, as shown with respect to FIG. 18.

The symbols carried by filter assemblies 1112, 1114, 1122 and 1124 are depicted in FIG. 19.

When the modulation means 1140 switches on light-emitting diode 1130 and switches off light-emitting diode 1132, the light source emits light rays with wavelengths of between 400 and 550 nanometers. The light rays emitted by the light source that reach filters 1112 pass through them within the shape of the symbol represented by this filter and are absorbed outside this shape. The rays that reach filters 1114 are absorbed just as well within the shape of the symbol carried by filter 1114 as outside this symbol because this filter is absorbent in the emission spectrum of light-emitting diode 1130. For key 1110, the visible symbol is therefore the symbol carried by filter 1112, in this case “1”, which appears in blue on a black background.

Equally, for key 1220, the visible symbol is that which is carried by filter 1222, in this case “2”, which appears in black on a blue background.

When the modulation means 1140 switches on light-emitting diode 1132 and switches off light-emitting diode 1130, the light source emits light rays with wavelengths of between 550 and 700 nanometers. The light rays emitted by the light source that reach filters 1114 pass through them within the shape of the symbol represented by this filter and are absorbed outside this shape. The rays that reach filters 1112 are absorbed just as well within the shape of the symbol carried by filter 1112 as outside this symbol because this filter is absorbent in the emission spectrum of light-emitting diode 1132. For key 1110, the visible symbol is therefore the symbol carried by filter 1114, in this case “>”, which appears in orange on a black background.

Equally, for key 1220, the visible symbol is the symbol carried by the filter 1124, in this case “<”, which appears in black on an orange background.

Thus, the implementation of the present invention enables, by the modulation value of a physical characteristic of the light emitted by the light source, in this case the wavelengths of the emitted rays, the display of one or other symbol on each key of keyboard 1100.

For example, the implementation of the present invention enables the symbols “>” and “<” to be displayed when the keyboard is used for games, to indicate the directions of movement needed to play the game, and the symbols “1” and “2” to be displayed when the keyboard is used to enter figures or numbers, in order to perform a calculation or make a telephone call.

In a variant of the eighth embodiment, illustrated in FIGS. 16 through 19, the light source comprises a light-emitting diode whose emission wavelength spectrum depends on at least one electrical characteristic of the signal that is applied to it, for example the voltage.

In a variant of the eighth embodiment, illustrated in FIGS. 16 and 19, the light source comprises two light-emitting diodes emitting in the same visible spectrum, each associated to one chromatic filter.

In a variant of the eighth embodiment, illustrated in FIGS. 16 through 19, the light source comprises a light-emitting diode followed by a dichroic polarizing filter placed optically after a single-cell liquid crystal screen and comprising a filter polarizing only on its upstream face on the light source side, the control for this liquid crystal screen making it possible to modify the liquid crystal screen's output polarization and, consequently, the color of the light rays coming from the light source.

It is noted here that the number of filters that can be juxtaposed and the number of corresponding light-emitting diodes are not limited to two but can match the number of different spectral bands that the light source and the chromatic filters can have, for example ten if the disjoint spectral bands each cover a spectrum width of thirty nanometers, and that the filters have an absorption spectrum corresponding to the possible emission spectra of the light source.

In the ninth embodiment, illustrated on FIGS. 20 and 21, three filter assemblies juxtaposed alternately are used.

FIG. 20 shows a keyboard 1150 comprising keys 1160 and 1170, equipped with three filter assemblies juxtaposed alternately, 1162, 1163 and 1164 respectively, key 1160, and 1172, 1173 and 1174, key 1170, and electrical contactors, 1166 and 1176 respectively. A light source is made up of three light-emitting diodes 1180, 1182 and 1184 controlled by a modulation means 1190.

The electrical contactors 1166 and 1176 make an electrical contact between their terminals when keys 1160 and 1170 respectively are pressed or pushed. The modulation means 1190 is an electrical switch that powers one or others of the light-emitting diodes 1130, 1132 and 1134.

The light-emitting diodes 1130, 1132 and 1134 emit in different spectral bands, preferably disjoint. For example, light-emitting diode 1130 emits light rays with wavelengths of between 400 and 500 nanometers, light-emitting diode 1132 emits light rays with wavelengths of between 500 and 600 nanometers and light-emitting diode 1134 emits light rays with wavelengths of between 600 and 700 nanometers.

Filter assemblies 1162, 1163 and 1164 are juxtaposed alternately, that is to say that between two filters 1162 there is a filter 1163 and a filter 1164, that between two filters 1163 there is a filter 1162 and a filter 1164, that between two filters 1164 there is a filter 1163 and a filter 1162 and that these filter assemblies are, optically, in parallel on the optical paths of the light rays coming from light sources 1180, 1182 and 1184.

Different symbols are formed on filter assemblies 1162, 1163 and 1164, for example “1”, “A” and “>”, filters 1162, 1163 and 1164 being absorbent for all the visible wavelengths outside the shapes of these symbols and having, within the shape of the symbols, transmission spectra respectively corresponding noticeably to the emission spectra U1, U2 and U3 of light-emitting diodes 1180, 1182 and 1184, as shown with respect to FIG. 21.

Different symbols are formed on filter assemblies 1172, 1173 and 1174, for example “2”, “B” and “<”, filters 1172, 1173 and 1174 being absorbent for all the wavelengths within the shapes of these symbols and having, outside the shape of the symbols, absorption spectra respectively corresponding noticeably to the emission spectra U1, U2 and U3 of light-emitting diodes 1180, 1182 and 1184, as shown with respect to FIG. 21.

It is understood that when the modulation means 1190 only switches on light-emitting diode 1180, only the symbols carried by filter assemblies 1162 and 1172 appear, in blue on a black background and in black on a blue background respectively. Equally, when the modulation means 1190 only switches on light-emitting diode 1182, only the symbols carried by filter assemblies 1163 and 1173 appear, in green-yellow on a black background and in black on a green-yellow background respectively. Lastly, when the modulation means 1190 only switches on light-emitting diode 1184, only the symbols carried by filter assemblies 1164 and 1174 appear, in red on a black background and in black on a red background respectively.

In the tenth embodiment illustrated in FIGS. 22 and 23, assemblies of polarizing filters having the same polarization axis and a polarization axis perpendicular to the other polarizing filter assembly, are used. Different symbols are formed on these polarizing filter assemblies and, in order to make a given symbol appear, the main polarization direction of a light source's emission is modulated.

It is noted that in order to form the symbols on polarizing filters, one can take polarizing filters and locally destroy their polarization capability by local heating. Alternatively, a polarizing filter can be cut out and the desired shape stuck onto a key of a keyboard.

FIGS. 22 and 23 show a keyboard 1200 comprising keys 1210 and 1220, equipped with filter assemblies, 1212 and 1214 respectively, key 1210, and 1222 and 1224, key 1220, and electrical contactors, 1216 and 1226 respectively. A light source is made up of two light-emitting diodes 1230 and 1232 controlled by a modulation means 1240.

The electrical contactors 1216 and 1226 make an electrical contact between their terminals when keys 1210 and 1220 respectively are pressed or pushed. The modulation means 1240 is an electrical switch that powers one or other of the light-emitting diodes 1230 and 1232.

The light-emitting diodes 1230 and 1232 emit visible light rays having perpendicular polarization axes, between the rays emitted by the two diodes. For example, light-emitting diode 1230 emits light rays whose polarization axis is parallel to the cross-section plane used in FIG. 22 and light-emitting diode 1232 emits light rays whose polarization axis is perpendicular to this cross-section plane. To this end, for example, diodes 1230 and 1232 emit over the whole visible spectrum and are associated with or incorporate polarizing filters (not shown).

Filter assemblies 1212 and 1214, on the one hand, and 1222 and 1224, on the other hand, are juxtaposed alternately, that is to say that between two filters 1212 and 1222 respectively, there is a filter 1214 and 1224 respectively, and vice versa and that these filter assemblies are, optically, in parallel on the optical paths of the light rays coming from light sources 1230 and 1232. Different symbols are formed on filter assemblies 1212 and 1214, for example “1” and “>”, filters 1212 and 1214 being respectively transparent outside the shapes of these symbols and having, within the shape of the symbols, polarization axes respectively corresponding to the polarization axes of light-emitting diodes 1230 and 1232.

Different symbols are formed on filters 1222 and 1224, for example “2”, and “<”, filters 1222 and 1224 respectively being transparent inside the shapes of these symbols and having, outside the shape of these symbols, polarization axes respectively corresponding to the polarization axes of the light-emitting diodes 1230 and 1232.

When the modulation means 1240 switches on light-emitting diode 1230 and switches off light-emitting diode 1232, the light source emits light rays whose polarization axis is parallel to the cross-section plane used in FIG. 19. The light rays emitted by the light source thus pass through filter 1212 just as well outside the symbol represented by this filter as they do within this symbol. Elsewhere, other light rays pass through filter 1214 outside the shape of the symbol carried by filter 1214 and are stopped within the shape of the symbol. For key 1210, the visible symbol is therefore the symbol carried by filter 1214, in this case “>”, which appears in black on a background whose color corresponds to the emission spectrum of light-emitting diode 1230, for example on a white background.

Equally, for key 1220, the visible symbol is that which is carried by filter 1224, in this case “<”, which appears lit up on a black background, the color of the symbol corresponding to the emission spectrum of light-emitting diode 1230, for example white.

Conversely, when the modulation means 1240 switches on light-emitting diode 1232 and switches off light-emitting diode 1230, the symbols which become visible are the symbols carried by filters 1212 and 1222, which are “1” and “2” respectively.

Thus, the implementation of the present invention enables, by the modulation value of a physical characteristic of the light emitted by the light source, in this case the polarization of the emitted rays, the display of one or other symbol on each key of keyboard 1200.

In a variant of the tenth embodiment, illustrated in FIGS. 22 and 23, the light source comprise a light-emitting diode followed by a single-cell liquid crystal screen and comprising only an input polarizing filter, the control for this liquid crystal screen making it possible to modify the liquid crystal screen's output polarization.

In the eleventh embodiment, illustrated in FIGS. 24 and 25, parallel partially frosted optical conductors (in this case optic fibers) are used to form different symbols and, in order to make a given symbol appear, light is emitted in one or other of the optical conductors.

FIGS. 24 and 25 show a keyboard 1600 comprising keys 1610 and 1620, equipped with optic fiber networks juxtaposed in parallel and alternately, 1612 and 1614, and electrical contactors, 1616 and 1626 respectively. A light source is made up of two light-emitting diodes 1630 and 1632 controlled by a modulation means 1640.

The electrical contactors 1616 and 1626 make an electrical contact between their terminals when keys 1610 and 1620 respectively are pressed or pushed. The modulation means 1640 is an electrical switch that powers one or other of the light-emitting diodes 1630 and 1632.

The light-emitting diodes 1630 and 1632 are placed opposite the inputs of the different optic fiber networks. For example, light-emitting diode 1630 emits light rays in optic fiber network 1612 and light-emitting diode 1632 emits light rays in optic fiber network 1614.

For keyboard key 1610, different symbols are formed over optic fiber networks 1612 and 1614, for example “1” and “>”, optic fiber networks 1612 and 1614 being frosted in the shape of these symbols respectively.

For keyboard key 1620, different symbols are formed over optic fiber networks 1612 and 1614, for example “2” and “<”, optic fiber networks 1612 and 1614 being frosted in the shape of these symbols respectively.

In FIG. 25, the frosted portions of the optic fibers are represented in black.

When the modulation means 1640 switches on light-emitting diode 1630 and switches off light-emitting diode 1632, the light source emits light rays in fiber optic network 1612, which, in the frosted areas, appears bright, the visible symbols thus being the symbols “1” and “2”.

When the modulation means 1640 switches on light-emitting diode 1632 and switches off light-emitting diode 1630, the light source emits light rays in fiber optic network 1614, which, in the frosted areas, appears bright, the visible symbols thus being the symbols “>” and “<”.

Thus, the implementation of the present invention enables, by the modulation value of a physical characteristic of the light emitted by the light source, in this case the position of the emission of the emitted rays, the display of one or other symbol on each key of keyboard 1600.

For all the embodiments shown above incorporating filters absorbing light rays of certain wavelengths, these filters may be inference filters in which layers of material with different optical indexes are superposed, or gelatins, transparent or translucent media on which patterns, symbols or messages are printed with colored inks or marked with a marker giving a colored ink or a colored chalk. This last instance has the advantage of making it possible to inscribe and re-inscribe, retroactively, messages in different colors on the same transparent or translucent medium, for example a back-lit panel or table, each marker ink corresponding to one of the color spectra selectively emitted by the back-lighting light source or sources. One application of this instance can be used with re-inscribable display panels for retailers, for example to show promotions or menus. By using the present invention, several messages can be displayed in succession and animated on the same panel.

FIG. 26 shows an electronic circuit 850 linked to a keyboard 800 in an electrical device 890. The electronic circuit 850 comprises a switching control means 855 and an operation means 860 for the selected symbols at the keyboard 800.

In the embodiment illustrated in FIG. 26, the switching control means 855 comprises a sensor for a physical characteristic 865 and two outputs, of which one controls the modulation means 840 for the keyboard 800 and the other is linked to the operation means 860.

The electronic circuit 850 is adapted to provide at least one of the following functions of the electronic device 890, by means of special circuits (not shown) for operation means 860:
personal digital assistant (known under the name PDA),
organizer,
telephone, especially a mobile telephone,
terminal for access to the Internet or another computing network,
games console,
portable computer,
automatic teller machine,
dashboard,
watch,
remote control,
portable music player,
a positioning system, for example by reference to satellite signals,
audiovisual signal receiver, for example portable television or auto radio,
office or leisure electronic equipment,
fax machine,
photocopier,
scanner,
recorded media reader,
home system installation,
household appliance,
medical equipment,
measurement device,
automated analysis device,
automobile equipment,
signboard,
switch,
games system,
decorative element,
lamp,
electrical button and
display panel.

Keyboard 800 complies with an embodiment of the keyboard subject to the present invention, for example one of the embodiments discussed with reference to FIGS. 1 through 15.

The physical characteristic sensor 865 is adapted to pick up a variation in at least one physical characteristic, for example pressing on a key, optical masking, or a position of device 890. It may therefore be made up of, for example, at least one photodiode, of at least one phototransistor, of a manual switch, of a key of a keyboard, of an orientation sensor.

In a variant, the switching control means is a program or a program routine, for example acting according to the choice made by the user while navigating a menu of functions and parameters.

The change-over of the switching means causes the symbols displayed on keyboard 800 to change, and the interpretation of the symbols entered with this keyboard to change, in preparation for their use by the operation means 860.

For example, two groups of symbols representing two groups of letters of the alphabet where the change-over is controlled by means of a photosensitive sensor which can be masked by the user's finger.

According to another application example, in order to produce a universal remote control keyboard, the present invention makes it possible to successively assign the same keys of the keyboard to the different interfaces that the user is used to (television, music system, video recorder, digital media reader, etc).

In a variation, electronic circuit 850 is equipped with an environmental luminosity sensor (for example a photodiode exposed to the surrounding light) and controls the brightness of each light source, increasing it according to the environmental luminosity.

In a variation, the electronic circuit 850 is equipped with a sensor to detect the presence of the user's hand (for example, a pulsed infrared light emitter-receiver), as discussed with reference to FIGS. 27 through 30, in order to select the messages or symbols displayed according to the hand used to enter a symbol at the keyboard.

FIGS. 27 through 30 represent displays on keyboards adapted to different embodiments of the present invention.

In FIG. 27, a display on a keyboard adapted to an electronic device's use for voice telephony is represented. The symbols normally inscribed in large characters on the keys of a telephone's keypad are to be seen, displayed on the keyboard.

In FIG. 28, a display on a keyboard adapted to text uses (for example, taking notes, writing a short message, or SMS, storing a name or an address) is represented. The letters of the alphabet are there, displayed on the keyboard.

FIGS. 29 and 30 represent, respectively, displays for games interfaces and multimedia or organizer interfaces.

In a variation, a detecting means for detecting a presence, for example a pulsed infrared emitter-receiver, detects if a predetermined hand (for example the left hand) is used to enter a displayed symbol. The infrared emitter-receiver is, for the left hand, placed in the bottom left-had corner of the keyboard. The display is modified according to the hand that is used to enter a symbol, for example to make the symbols “A” through “M” appear for entry with the left hand on a keyboard with thirteen keys available for the alphabet and the letters “N” through “Z” for entry with the right hand.

FIG. 31 represents, schematically, a display that is the subject of the present invention utilizing an operation similar to that described with reference to FIGS. 12 and 13 in order to display different messages, for example advertisements, road signs, art displays, mass transit timetables.

In the embodiment of this display, chromatic filters are used that each carry a message to be displayed and, in order to make a given message appear, the spectral band of emission of a light source is modulated.

FIG. 31 shows a display panel 900 comprising display-filters 912, 913 and 914. A light source is made up of a source of white light 920 linked to a carousel bearing three chromatic filters 931, 932 and 933, made to move by a motor controlled by a modulation means 940 in order that one or other of the filters is opposite the light source 920.

Chromatic filters 931, 932 and 933 are adapted to let the light pass in three different spectral bands, preferably disjoint. For example, filter 931 is transparent to light rays with a wavelength of between 400 and 500 nanometers, filter 932 is transparent to light rays with a wavelength of between 500 and 600 nanometers and filter 933 is transparent to light rays with a wavelength of between 600 and 700 nanometers.

Displays 912 through 914, which are made up of filters, possibly diffusing, are superposed, that is to say that they are placed in succession on the optical path of the light rays coming from light source 920. Displays 912 through 914 each carry a message, these messages possibly being combined, that is to say that their composition is coordinated so that at least two messages carried by two displays form a new message.

Displays 912 through 914 are respectively transparent outside of the messages and possess, within the shape of the messages, absorption -spectra respectively corresponding noticeably to the three transparency spectra of filters 931, 932 and 933.

When the modulation means 940 causes filter 931 to be positioned in front of the source of white light 920, the light source emits light rays with wavelengths of between 400 and 500 nanometers. The light rays emitted by the light source pass through display 912 outside the message represented by this filter and are absorbed within this message because its absorption spectrum corresponds to the illuminating spectrum. Then, the remaining rays pass through displays 913 and 914 just as well within the shape of the message carried by these displays as they do outside these messages because these displays are transparent in the illuminating spectrum. The message displayed is therefore the one carried by display 912, which appears in black on a blue background.

When the modulation means 940 causes filter 932 to be positioned in front of the source of white light 920, the light source emits light rays with wavelengths of between 500 and 600 nanometers. The light rays pass through displays 912 just as well within the shape of the message carried by this display as they do outside this message because this display is transparent in the illuminating spectrum.

The light rays emitted by the light source pass through display 913 outside the message represented by this filter and are absorbed within this message because its absorption spectrum corresponds to the illuminating spectrum. Then the light rays pass through displays 914 just as well within the shape of the message carried by this display as they do outside this message because this display is transparent in the illuminating spectrum. The visible message is therefore the one carried by display 913, which appears in black on a green background.

When the modulation means 940 causes filter 933 to be positioned in front of the source of white light 920, the light source emits light rays with wavelengths of between 600 and 700 nanometers.

The light rays emitted by the light source pass through displays 912 and 913 just as well within the shape of the message carried by these displays as they do outside these messages because these displays are transparent in the illuminating spectrum.

The light rays then pass through display 914 outside the message represented by this filter and are absorbed within this message because its absorption spectrum corresponds to the illuminating spectrum.

The visible message is therefore the one carried by display 914, which appears in black on a red background.

The display procedure corresponding to the systems illustrated in FIGS. 1 through 15, 31, 33 and 34 comprises:
a switching step for switching on a light source adapted to light up, by backlighting, a display surface equipped with at least two filters superposed,
a modulating step for modulating at least one physical characteristic of said light source, the two, at least, superposed filters of the display surface each corresponding to a value of the physical characteristic modulated by the modulation means and to a message or a symbol to be displayed on said display surface.

In the case of keyboards, the procedure also comprises a detecting step for detecting an interaction between the user and at least one key of the keyboard and a matching step for matching this interaction to a meaning corresponding to each symbol displayed on the keyboard for the modulation value of the physical characteristic utilized at the time of the interaction, said meaning corresponding thus to the modulation value of the physical characteristic of the light source and varying with it.

Thus, the implementation of the present invention enables, by the modulation value of a physical characteristic of the light emitted by the light source, in this case the wavelength of the emitted rays, the display of one or other message on the display panel 900.

FIG. 32 represents, schematically, a display that is the subject of the present invention utilizing an operation similar to that described with reference to FIGS. 20 and 21 in order to display different messages, for example advertisements, road signs, art displays, mass transit timetables.

In the embodiment of this display, chromatic filters are used that each carry a message to be displayed and, in order to make a given message appear, the spectral band of emission of a light source is modulated.

FIG. 32 shows a display panel 1900 comprising filter assemblies, in this case square, juxtaposed and alternated 1912, 1913 and 1914. A light source is made up of a source of white light 1920 linked to a carousel bearing three chromatic filters 1931, 1932 and 1933, made to move by a motor controlled by a modulation means 1940 in order that one or other of the filters 1931, 1932 and 1933 is opposite the light source 1920.

Chromatic filters 1931, 1932 and 1933 are adapted to let the light pass in three different spectral bands, preferably disjoint. For example, filter 1931 is transparent to light rays with a wavelength of between 400 and 500 nanometers, filter 1932 is transparent to light rays with a wavelength of between 500 and 600 nanometers and filter 1933 is transparent to light rays with a wavelength of between 600 and 700 nanometers.

Filter assemblies or displays 1912 through 1914 each carry a message, these messages being, possibly, combined, that is to say that their composition is coordinated so that at least two messages carried by two filter assemblies or displays form a new message.

Filter assemblies 1912 through 1914 are respectively absorbent outside of the messages and possess, within the shape of the messages, transmission spectra respectively corresponding noticeably to the three transparency spectra of filters 1931, 1932 and 1933.

It is understood that, depending on the filter 1931, 1932 or 1933 which is in front of the light source 1920, the messages that are visible are those carried by filter assemblies 1912, 1913 and 1914 respectively.

In a variation, at least two light sources are utilized in order to create animation effects to what is seen displayed, for example cross fading or gradual transition, from a point or a side to the whole of the display surface, between the messages likely to be displayed. In variations, the messages are combined, at least two messages carried by two filter assemblies juxtaposed alternately being linked, for example in an advertising message in two colors. The use of two light sources thus enables the different colors of the same message to appear one after another in order to attract attention.

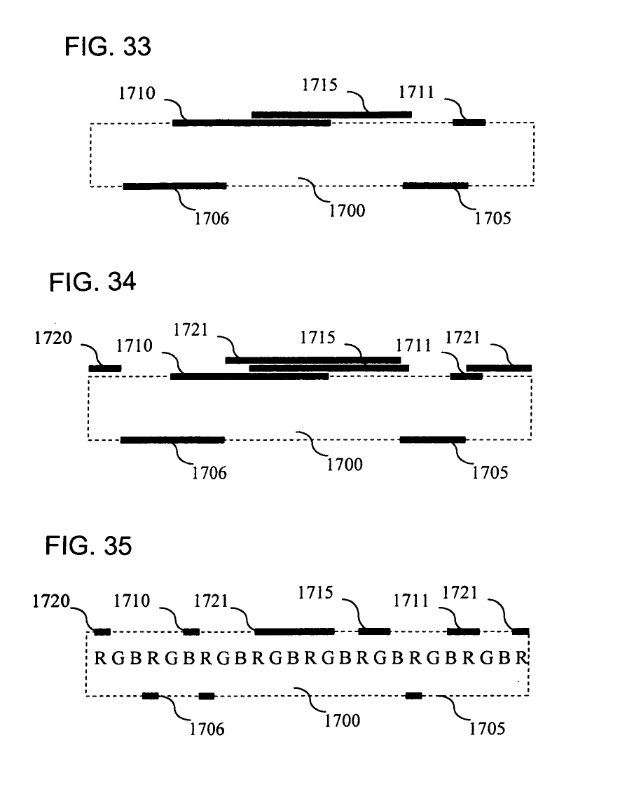

FIGS. 33 through 35 show a display printed on each surface with different colors on the different surfaces representing different symbols or messages or elements of coordinated messages. These are not to scale and only a small part of the display is represented, in cross section, in the form of a rectangle 1700 in broken lines. The thick lines, in black, represent the different areas having received ink. In this case, it has been assumed that only three spectral ranges were used, for example:
a spectral range of red tones, on the front surface of each of the displays (at the bottom of each of the figures) and, possibly also on the rear surface (FIGS. 34 and 35) and
two spectral ranges, respectively greens and blues, on the rear surface of each of these displays (on the top in each figure).

In FIG. 33, the inks are superposed on the rear surface. The areas having received the red ink are referenced 1705 and 1706. The areas having received the green ink are referenced 1710 and 1711 and the area having received the blue ink is referenced 1715. It is understood that these area are independent and can represent independent or coordinated symbols or messages.

FIG. 34 shows the same elements as FIG. 33 with the addition of areas 1720 and 1721, in red ink, on the rear surface, using the same ink as for areas 1705 and 1706 but forming their complement in such a way that each part of the display that has red ink on the front surface does not have red ink on the rear surface, and vice versa.

In FIG. 35, the inks present the same symbols and message as in FIG. 34, with the same colors, but they are not superposed, thus forming filters juxtaposed alternately.

At environmental luminosity, when the backlighting light source is switched off, only that which is printed on the front surface is visible. At night, when the back-lighting light source is switched on and emits, over at least part of the display, colors corresponding to two of the spectral ranges, only the message corresponding to the third spectral range is visible. At night, when the backlighting light source is switched on and emits, over at least part of the display, colors corresponding to just one of the spectral ranges, only the messages corresponding to the other spectral ranges are visible.

With reference to the embodiments illustrated in FIGS. 34 and 35, back-lighting with a white light makes the message carried by the red ink disappear, because all parts of the display carry red ink, either on the front surface or on the rear surface, and the messages carried by the other two colors appear.

It is noted that using the front surface to display a message or symbol when the light source is switched off is not limited to the displays but may also be used equally well for displays as for push buttons, keyboards or for other applications of the present invention detailed in the description.

The display procedure corresponding to the systems illustrated in FIGS. 16 through 25, 32 and 35 comprises:
a switching step for switching on a light source adapted to light up, by backlighting, a display surface,
a modulating step for modulating at least one physical characteristic of said light source, the display surface being equipped with at least two filter assemblies juxtaposed alternately, each filter assembly corresponding alternately to a value of the physical characteristic modulated by the modulation means and to a message to be displayed on said display surface, said filters being placed on an optical path taken by the light rays coming from the light source.

In the case of keyboards, the procedure also comprises a detecting step for detecting an interaction between the user and at least one key of the keyboard and a step matching this interaction to a meaning corresponding to each symbol displayed on the keyboard for the modulation value of the physical characteristic utilized at the time of the interaction, said meaning corresponding thus to the modulation value of the physical characteristic of the light source and varying with it.

Thus, the implementation of the present invention enables, by the modulation value of a physical characteristic of the light emitted by the light source, in this case the wavelength of the emitted rays, the display of one or other message on the display panel 1900.

In a variant of all the embodiments, illustrated in FIGS. 31 or 32, the light source comprises three lights emitting in three visible spectra or each associated to a chromatic filter.

It is noted here that the number of filters that can be juxtaposed and the number of corresponding light-emitting diodes are not limited to two but can match the number of different spectral bands that the light source and the chromatic filters can have, for example ten if the disjoint spectral bands each cover a spectrum width of thirty nanometers, and that the filters have an absorption spectrum corresponding to the possible emission spectra of the light source.

It is noted that cross fading can be performed between the messages carried by the displays, by gradually reducing the intensity of the light emitted in one spectral band and by gradually increasing the intensity of light emitted in another spectral band or by controlling independently the intensity of light in the different emission spectral bands.

Animation effects can also be realized, by sequencing the light sources utilized with reference to the different parts of the display.

The same principle can be utilized in toys or gadgetry, for example pens with an image animated according to the light source or sources switched on.

1-20. (canceled)

21. A keyboard, comprising:
at least one key, said at least one key having:
a plurality of superposed filters each corresponding to a value of a physical characteristic of the light and to a message to be displayed on said at least one key; and
a contactor adapted to supply a signal representative of an interaction between a user and said key;
a light source adapted to light up, by backlighting, the superposed filters of said at least one key;
a modulator for modulating at least one physical characteristic of said light source, adapted to modulate at least one value of the physical characteristic of the light emitted by said light source, to make visible a message placed on said filter of said at least one key; and
a reception device receiving signals from said contactor, said reception device being adapted to assign different symbols to said signals, in line with a switching carried out by a switching means.

22. The keyboard according to claim 21, wherein each filter is made up of a transparent or translucent medium having the message printed thereon.

23. The keyboard according to claim 21, wherein said light source is adapted to light up jointly, by backlighting, a plurality of keys and the superposed filters thereof, and wherein said modulator of at least one physical characteristic of said light source is adapted to modulate at least one value of the physical characteristic of the light emitted by the light source and received by a plurality of keys, in order to jointly make visible the messages placed on a said filter of each said key.

24. The keyboard according to claim 21, wherein each filter has transparent areas and areas with absorption spectra respectively corresponding substantially to emission spectra of said light source, for different modulation values of the modulator.

25. The keyboard according to claim 21, wherein each said key comprises at least three superposed filters, said filters having transparent areas and areas with absorption spectra respectively corresponding substantially to emission spectra of said light source, for at least three modulation values of said modulator.

26. The keyboard according to claim 21, wherein said modulator is adapted to modify a spectral band of light reaching said filters and said filters provide spectral bands of different transparency.

27. The keyboard according to claim 21, wherein said light source (630) comprises a light-emitting diode having a spectral band of emission that varies according to an electrical characteristics of a power signal applied thereto, and said modulator is adapted to modify said electrical characteristics.

28. The keyboard according to claim 21, wherein said light source comprises at least two independent electro-optical transducers placed in parallel on an optical path of light rays from said light source to said key, and said modulator is adapted to control alternately the light emission by either one of said electro-optical transducers.

29. The keyboard according to claim 21, wherein said modulator is adapted to modify a principal axis of polarization of light rays reaching said filters, and said filters have mutually different transparencies according to an axis of polarization.

30. The keyboard according to claim 21, wherein said filters comprise components adapted to produce constructive or destructive interferences depending on an angle of incidence of the light rays and said modulator is adapted to modify the angle of incidence of the light rays emitted by said light source.

31. The keyboard according to claim 21, wherein said filters comprise holograms and said light source comprises at least two electro-optical transducers adapted to light up said holograms with different angles of incidence in order to make different symbols or messages appear on said key, and wherein said modulator is adapted to modify the angle of incidence of the light rays emitted by said light source.

32. The keyboard according to claim 21, wherein said filters comprise components adapted to produce total or partial reflections depending on an angle of incidence of the light rays and said light source comprises at least two electro-optical transducers adapted to light up said filters with different angles of incidence in order to make different symbols or messages appear on the key, and wherein said modulator is adapted to modify the angle of incidence of the light rays emitted by said light source.

33. The keyboard according to claim 21, wherein said filters comprise components adapted to realize different light transfers depending on an angle of incidence of the light rays and said light source comprises at least two electro-optical transducers adapted to light up said filters with different angles of incidence in order to make different symbols or messages appear on the key, and wherein said modulator is adapted to modify the angle of incidence of the light rays emitted by said light source.

34. The keyboard according to claim 21, which comprises at least one optical fiber defining an optical path from said light source to said key.

35. The keyboard according to claim 21, which comprises at least one optical reflector element defining an optical path from said light source to said key.

36. The keyboard according to claim 21, wherein at least two of said filters of at least one key are each formed of an assembly of filters, with the assemblies of filters being juxtaposed alternately in the key.

37. In combination with an electronic device selected from the group consisting of:
a personal digital assistant, an organizer, a telephone, a games console, a portable computer, an Internet access terminal, an Automatic Teller Machine, a watch, a remote control, a portable music player, a positioning system and an audiovisual signal receiver, office or leisure electronic equipment, a facsimile machine, a photocopier, a scanner, a recorded media reader, a home system installation, a household appliance, a medical device, a measurement device, an automated analysis device, automobile equipment, a signboard, a switch, a games system, a decorative element, a lamp, and/or a display panel;
a key according to claim 21 integrated with the electronic device.

38. A display method, which comprises the following method steps:
switching a light source adapted to light up, by backlighting, at least one key, each key including:
at least two superposed filters, each filter corresponding to a value of a physical characteristic of the light and to a message to be displayed on the key; and
a contactor adapted to deliver a signal representative of an interaction between a user and the key;
modulating at least one value of the physical characteristic of the light emitted by the light source, in order to jointly make visible a message placed on a filter of each key; and
receiving signals coming from each of the contactors, during which different symbols are assigned to the signals, depending on a state of a switching means performing the switching.
